(19) United States
(12) Patent Application Publication
(10) Pub. No.: US 2009/0065541 A1
(43) Pub. Date: Mar. 12, 2009

(54) Shopping cart mounted coupon dispensing system and method

(76) Inventor: James Paul Thomas, Holt, FL (US)

Correspondence Address: James P Thomas, 12340 Wildlife Rd, Holt, FL, 32564, US

(21) Appl. No.: 11/852,286

(22) Filed: Sep. 8, 2007

(51) Int. Cl. B60R 7/00; B62D 39/00; G06Q 30/00

(52) U.S. Cl. 224/277; 280/33.993; 705/14

(57) ABSTRACT

A coupon dispensing system is adapted to be mounted to a shopping cart for distributing coupons in a retail store. A plurality of tear away coupon pads and/or coupon dispensers are mounted on surfaces of a shopping cart basket. A user person is enlisted by incentives to use the shopping cart mounted coupon dispensing system during their grocery shopping trip. As other shoppers in the store aisles approach the shopping cart mounted coupon dispensing system, they are invited to remove coupons from the shopping cart they would like to use during their grocery shopping trip. The shopping cart mounted coupon dispensing system is quickly and easily reloaded with tear away coupon pads and/or coupon dispensers upon exhaustion of coupons. Further including a method of monitoring coupon redemptions to correspond to an entity that is paid a fee for each coupon redeemed originating from said shopping cart mounted coupon dispensing system.

### BACKGROUND OF THE INVENTION

1. Field of the Invention

The present invention relates, in general, to shopping carts and coupon dispensing systems and in particular to a shopping cart mounted coupon dispensing system and method for dispensing large groups of coupons where they can be viewed and easily picked up by grocery shoppers.

2. Description of the Related Art

It is well known that manufacturers of food and other consumer products, in the course of their marketing activities, often wish to increase the sales of particular items by offering advantageous price terms to their customers. One method of doing so is by employing coupons. Typically, the coupon allows the customer to purchase the product for less than the list price of the product in the store. Such coupons have in the past been printed in general circulation newspapers and magazines, which required the consumer to purchase newspapers and magazines and search the publications for the coupons and clip the coupons out of the publication. The customer also had to remember to carry them to the store where they were to be redeemed in. This, of course, was inconvenient for the customer and potentially may result in lost sales due to the number of steps in the redemption process. It is generally accepted by the industry that less than 2% of coupons are ever redeemed. These low redemption rates are an indication that coupons must become more user-friendly. There is a need to enhance consumer motivation to purchase products, save the consumer time and money, and provide more efficient and cost effective cooperative advertising opportunities for CPG manufacturers.

Recently, stores have displayed coupon dispensers on store shelves and coupons typically glued to tear-away pads for use by the customers in the store. The customer may tear the coupon off the pad and carry it with her or him to the check-out area of the store where the product is purchased. Often the pad is glued or adhesively attached to a fiberboard or cardboard display so that when the tear-away coupons are consumed the entire display must be replaced with a new display. Since the coupons often are organized with only single brand coupons per display, the customer may be required to go from point to point in the store looking for additional coupons for the same or similar types of foodstuffs, resulting in inconvenience for the customer. In addition, if the coupons have been used up, due to higher demand than anticipated for the product, the customer may no longer be able to take advantage of the advantageous pricing, and the seller of the product may be unable to make additional sales due to the exhaustion of the coupons. It is clear that it is desirable to be able to display coupons prominently on shopping carts in the store where the customers can easily obtain them. Among patents related to dispensing of coupons mounted to shopping carts are U.S. Pat. No. 6,714,837 to Brackmann, et al. discloses a coupon applicator and methods of applying coupon strips to grocery carts. U.S. Patent Application No. 20050218612 to Malchow discloses a shopping cart handle sanitary protector and coupon that includes a handle shield for placement about the handle of a conventional shopping cart. The handle shield is formed of sheet material that forms a sleeve that surrounds the handle to shield the hands of the user of the cart from contacting the handle, and a hang tag is suspended from the handle that bears advertisements, coupons, and/or bar codes for displaying to the shopper the different goods available in the store and for redeeming at the checkout counter of the store. U.S. Patent Application No. 20050218612 to Coty discloses a handle cover promotions system includes generally tubular shopping cart handle covers. The handle covers have coupons printed thereon and are manufactured from recyclable material. U.S. Pat. No. 7,195,155 to Garberg, et al. for a method of advertising and dispensing products by conversion of a shopping cart into a dispensing display and a method of advertising and dispensing products. U.S. Pat. No. 5,597,104 to Elliott discloses a disposable coupon holder for a shopping cart that includes a one-piece coupon caddy sheet formed with a series of coupons. The sheet has a pair of ears that are bent rearwardly from the body of the sheet.

The two ears have slots that receive the horizontal bar of a shopping cart basket so that the coupons are visible to the shopper. U.S. Pat. No. 6,158,640 to Karp, et al. discloses an elongated shopping cart attachment having opposing tongues that includes a low cost shopping cart attachment having an indicia display area along with a shopping list, coupon, circular holder. The shopping cart attachment is intended to be removably attach onto a shopping cart handle facing a shopper that is pushing on the handle of the shopping cart so that the indicia display area and the papers releasably retained in the shopping list, coupon, circular holder are easily viewed by the shopper

The aforementioned prior art patents are primarily related to displaying a small amount of coupons on a shopping cart handle that are intended for the cart users only.

What is needed is a coupon dispensing system and method that can display large amounts of coupons prominently on sides of shopping carts where customers can easily obtain them. Including a method for easy and rapid dispensing and replenishment of a large amount of coupons at one time so that when the coupons are exhausted, they may be quickly and easily restocked on the shopping cart mounted coupon dispensing system.

### SUMMARY OF THE INVENTION

The present invention is directed to a system for dispensing discount coupons in a retail store. A shopping cart having a basket and wheels includes a plurality of removably attachable tear away coupon pads and/or coupon dispensers mounted on a surface of at least one front wall, rear wall, bottom wall, and opposed side walls of said shopping cart basket. An entity is enlisted by incentives to display the shopping cart mounted coupon dispensing system in a retail store. A user person is enlisted by incentives to use the shopping cart mounted coupon dispensing system during their grocery shopping trip. As other shoppers in the store aisles approach the shopping cart mounted coupon dispensing system, they are invited to remove coupons from the shopping cart they would like to use during their grocery shopping trip. The shopping cart mounted coupon dispensing system is quickly and easily reloaded with tear away coupon pads and/or coupon dispensers upon exhaustion of coupons. The shopping cart mounted coupon dispensing system and method further includes a method of monitoring coupon redemptions wherein graphical bar code printed on each coupon corresponds to an entity that is paid a fee for each coupon redeemed originating from said shopping cart mounted coupon dispensing system.

It is another aspect of the present invention to provide a shopping cart mounted coupon dispensing system and method which is able to display large amounts of coupons prominently on sides of shopping carts in a retail store where grocery shoppers can easily obtain them.

It is another aspect of the present invention to provide a shopping cart mounted coupon dispensing system and method with removably attachable tear away coupon pads and/or coupon dispensers for easy loading onto the shopping cart mounted coupon dispensing system.

It is another aspect of the present invention to provide a shopping cart mounted coupon dispensing system and method of monitoring coupon redemptions wherein said graphical bar code printed on each coupon corresponds to an entity that is paid a fee for each coupon redeemed originating from said shopping cart mounted coupon dispensing system.

Other aspects of the present invention will become apparent upon a perusal of the specification and claims in light of the accompanying drawings.

### BRIEF DESCRIPTION OF THE DRAWINGS

FIG. 1 is a top left prospective view of the shopping cart mounted coupon dispensing system according to the preferred embodiment of the present invention;

FIG. 2 is a prospective view of the tear away coupon display pad of the shopping cart mounted coupon dispensing system as shown in FIG. 1;

### DESCRIPTION OF THE PREFERRED EMBODIMENT

The present invention, the shopping cart mounted coupon dispensing system 10 is comprised of a plurality of components. Such components are individually configured and correlated with respect to each other so as to attain the desired objective. The description below describes the preferred embodiment of the invention with the attachment of tear away coupon display pads to the shopping cart but other types of coupon dispensers may include free standing insert coupons, cardboard box type coupon dispensers, electromechanical coupon dispensers, and combinations thereof could also be attached to the shopping cart mounted coupon dispensing system.

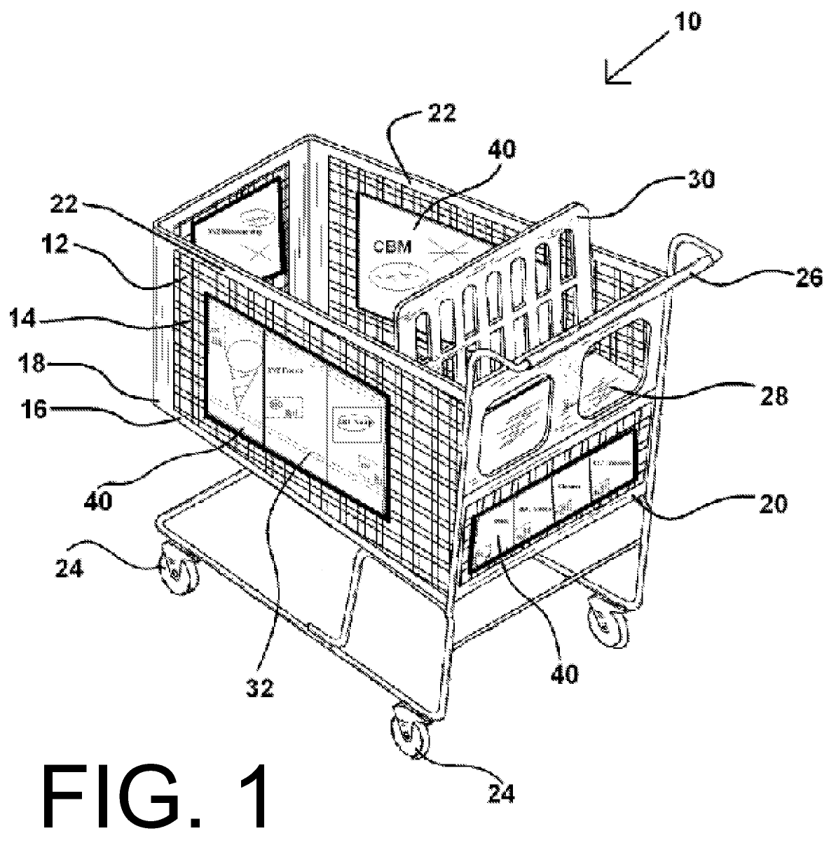

Referring now to the drawings, in particular to FIG. 1, the shopping cart mounted coupon dispensing system embodying the principles and concepts of the present invention and generally designated by the reference numeral 10 will be described.

First provided is a shopping cart 12 the shopping cart has a basket 14 the basket is for the receipt of groceries, the basket is fabricated of wire or plastic resin, the basket has an essentially horizontal bottom wall 16. The basket has a narrow front face wall 18. The rear of the basket has a wide rear face wall 20. The floor of the basket has tapering sides 22 between the front and rear wall faces. The shopping cart has wheels 24. The wheels 24 are provided beneath the shopping cart 12. The shopping cart has a handle 26. The handle 26 is provided above the shopping cart 12 and adjacent to the rear face 20. A sitting area 28 is provided in the basket 14. The sitting area 28 is formed of a pivotable backrest 30. The shopping cart 12 has a plurality of removably attached tear away coupon display pads 40 mounted on a surface of at least one of said front wall 18 rear wall 20 bottom wall 16 and opposed side walls 22 of shopping cart by means of a bungee cord assembly 32 that is wrappedly disposed around the stiff backing sheet 46 of the tear away coupon display pad 40 and holds the tear away coupon display pad 40 tightly against the shopping cart's rigid wall material.

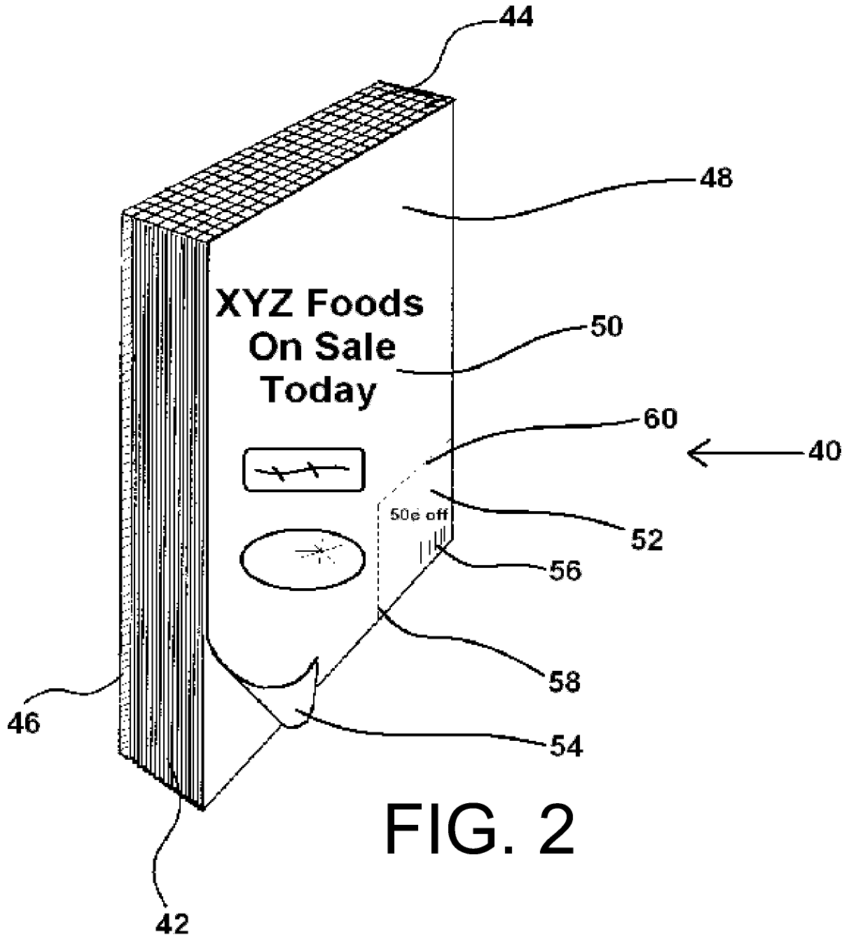

Referring now in particular to FIG. 2, the tear away coupon display pad embodying the principles and concepts of the present invention and generally designated by the reference numeral 40 will be described.

The illustrated assemblage of individual advertising and coupon display sheets 42 is held together by a suitable glue or padding adhesive 44 the tear away coupon display sheets 42 being attached to a relatively stiff backing sheet 46 by the padding adhesive 44 to form a removably attachable tear away coupon display pad 40. The removably attachable tear away coupon display pad 40 having a plurality of overlying individual tear sheets 42 each having a first and second side, said first side of sheet 48 having product bearing indicia 50 printed thereon and at least one coupon 52 printed thereon, said second side of sheet 54 having product bearing indicia 50 printed thereon and at least one coupon 52 printed thereon, said coupons 52 are redeemable for discount of the price of the goods advertised on the individual tear sheets 42, a bar code 56 is printed on each coupon 52 that corresponds to the product bearing indicia 50 advertised on the individual tear sheets 42. Perforated score lines 58 and 60 may be formed adjacent the advertisements for the purpose of neatly separating the coupons 52 from the individual tear away coupon display sheets 42.

There has been illustrated and described a particular embodiment of the present invention, it will be appreciated that numerous changes and modifications will occur to those skilled in the art, and it is intended in the appended claims to cover all those changes and modifications which fall within the true spirit and scope of the present invention.

What is claimed is:

I claim:

1. A shopping cart mounted coupon dispensing system and method comprising; a shopping cart having a basket for the receipt of groceries, the basket being fabricated of wire, plastic resin, and having an essentially horizontal bottom wall with a narrow front face wall and a wide rear face wall and tapering sides there between, the shopping cart also having wheels there beneath and a handle there above adjacent to the rear face, a sitting area in the basket, the sitting area being formed of a pivotable backrest with a top spaced a short distance from the rear face and having a generally horizontal seat between the backrest and the rear face, the sitting area being bounded on its side by the sides of the basket and further including apertures in the rear face above the seat for passage of legs of an infant sitting within the sitting area, a plurality of removably attachable tear away coupon pads and/or coupon dispensers are mounted on a surface of at least one front wall, rear wall, bottom wall, and opposed side walls of said shopping cart basket.

2. A shopping cart mounted coupon dispensing system as claimed in claim 1, wherein said coupon pads and/or coupon dispensers are removably attachable on an exterior and/or interior surface of at least one of said front wall, rear wall, bottom wall, and opposed side walls of said shopping cart basket.

3. A shopping cart mounted coupon dispensing system as claimed in claim 1, wherein said coupon pads and/or coupon dispensers are removably attachable to said shopping cart basket with at least one coupling member.

4. A shopping cart mounted coupon dispensing system as claimed in claim 3, wherein said at least one coupling member being selected from the group consisting of string, a threaded fastener, a cable tie, a wire twist tie, a bungee cord, and combinations thereof.

5. A shopping cart mounted coupon dispensing system as claimed in claim 1, wherein said coupon pads and/or coupon dispensers being selected from the group consisting of tear-away coupon pads, free standing insert coupons, cardboard box type coupon dispensers, electromechanical coupon dispensers, and combinations thereof.

6. A shopping cart mounted coupon dispensing system as claimed in claim 5, wherein said tear away coupon pads have a plurality of overlying individual tear sheets in overlying tablet form with each sheet having a first and second side, said first side having product bearing indicia and at least one coupon printed thereon, said second side having product bearing indicia and at least one coupon printed thereon, said coupons are redeemable for a discount off the price of goods advertised on the individual tear sheets.

7. A shopping cart mounted coupon dispensing system as claimed in claim 6, wherein said coupon includes a perforated score line between the coupon and the rest of the sheet.

8. A shopping cart mounted coupon dispensing system as claimed in claim 6, wherein said coupon includes a graphical bar code printed thereon that corresponds to the product advertised on the sheet.

9. A shopping cart mounted coupon dispensing system as claimed in claim 8, wherein said graphical bar code printed thereon corresponds to an entity that is paid a fee for each coupon redeemed originating from said shopping cart mounted coupon dispensing system.

10. A method of monitoring coupon redemptions originating from said shopping cart mounted coupon dispensing system, wherein said graphical bar code data is integrated into an electronic database for coupon management and data collection, coupon redemption data corresponds to an entity that is paid a fee for each coupon redeemed originating from said shopping cart mounted coupon dispensing system.

11. A method of encouraging usage of said shopping cart mounted coupon dispensing system, wherein a user person is enlisted by incentive to use said
